(19) United States
(12) Patent Application Publication
(10) Pub. No.: US 2025/0378989 A1
(43) Pub. Date: Dec. 11, 2025

(54) COIL PATTERN AND IC CARD HAVING THE SAME

(71) Applicant: TDK Corporation, Tokyo (JP)

(72) Inventors: Tomohiro MORIKI, Tokyo (JP); Shoma KAJIKIYA, Tokyo (JP)

(73) Assignee: TDK Corporation, Tokyo (JP)

(21) Appl. No.: 19/229,066

(22) Filed: Jun. 5, 2025

(30) Foreign Application Priority Data
Jun. 6, 2024 (JP) 2024-091931

(51) Int. Cl. H01F 27/28; G06K 19/077; H01F 38/14

(52) U.S. Cl. CPC H01F 27/2828; G06K 19/07781; H01F 38/14

(57) ABSTRACT

Disclosed herein is a coil pattern that includes a plurality of turns. Each of at least some of the turns includes: a first winding part wound in a first direction so as to surround a first opening area; a second winding part wound in a second direction so as to surround a second opening area; a first connection part connecting one end of the second winding part and one end of the first winding part; and a second connection part connecting other end of the second winding part and other end of the first winding part included in an adjacent turn. The plurality of turns include a first turn positioned at an innermost periphery in the second winding part. The first turn includes an additional pattern extending between the first and second connection parts and connected to the other end of the first winding part.

### CROSS-REFERENCE TO RELATED APPLICATION

This application claims the benefit of Japanese Patent Application No. 2024-091931, filed on Jun. 6, 2024, the entire disclosure of which is incorporated by reference herein.

### BACKGROUND

The present disclosure relates to a coil pattern and an IC card having the same.

U.S. Patent Application Publication No. 2015/0235122 discloses a coil pattern wound in a plurality of turns. Each of the turns constituting the coil pattern described in this publication has a card antenna wound in one direction and a coupling coil positioned in an opening area surrounded by the card antenna and wound in the opposite direction to the winding direction of the card antenna.

However, in the coil pattern described in U.S. Patent Application Publication No. 2015/0235122, when a short-circuit failure occurs in a conductor pattern constituting the innermost turn of the coupling coil, it cannot easily be detected by characteristic test.

### SUMMARY

A coil pattern according to an embodiment of the present disclosure is a coil pattern includes a plurality of turns. Each of at least some of the plurality of turns includes: a first winding part wound in a first direction so as to surround a first opening area; a second winding part wound in a second direction so as to surround a second opening area; a first connection part connecting one end of the second winding part and one end of the first winding part; and a second connection part connecting other end of the second winding part and other end of the first winding part included in an adjacent turn. The plurality of turns include a first turn positioned at an innermost periphery in the second winding part. The first turn includes an additional pattern extending between the first and second connection parts and connected to the other end of the first winding part.

### BRIEF DESCRIPTION OF THE DRAWINGS

The above features and advantages of the present disclosure will be more apparent from the following description of certain some embodiments taken in conjunction with the accompanying drawings, in which:

FIG. 1 is a schematic perspective view illustrating the outer appearance of an IC card 2 having a coil pattern according to an embodiment of the present disclosure;

FIG. 2 is a schematic exploded perspective view for explaining the structure of the IC card 2 having a coil pattern CP;

FIG. 3 is a schematic cross-sectional view for explaining the structure of the IC card 2 having a coil pattern CP;

FIG. 4 is a schematic perspective view of the IC module 60 as viewed from the back surface side;

FIG. 5 is a schematic diagram illustrating a state in which the IC card 2 and the card reader 6 communicate with each other;

FIG. 6 is a schematic plan view for explaining the configuration of the coil pattern CP;

FIG. 7 is an enlarged schematic plan view illustrating the second winding part 22 of the coil pattern CP and its periphery;

FIG. 8 is a schematic plan view for explaining a first modification of the coil pattern CP;

FIG. 9 is a schematic plan view for explaining a second modification of the coil pattern CP;

FIG. 10 is a schematic plan view for explaining a third modification of the coil pattern CP;

FIG. 11 is a schematic plan view for explaining a fourth modification of the coil pattern CP; and

FIG. 12 is a schematic plan view for explaining a fifth modification of the coil pattern CP.

### DETAILED DESCRIPTION OF THE EMBODIMENTS

The present disclosure describes a coil pattern in which a short-circuit failure occurring in a conductor pattern can be easily detected through a characteristic test.

Some embodiments of the present disclosure will be explained below in detail with reference to the accompanying drawings.

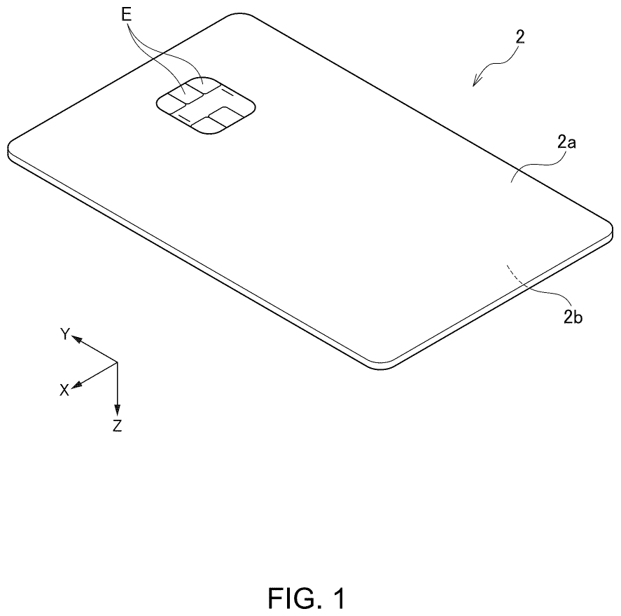

FIG. 1 is a schematic perspective view illustrating the outer appearance of an IC card 2 having a coil pattern according to an embodiment of the present disclosure.

As illustrated in FIG. 1, the IC card 2 according to the present embodiment has a plate-like body in which the Y-, X-, and Z-directions thereof are respectively defined as the longer side direction, shorter side direction, and thickness direction and has an upper surface 2a and a back surface 2b which constitute the XY plane. The IC card 2 incorporates therein an IC module to be described later, and a terminal electrode E of the IC module is exposed to the upper surface 2a of the IC card 2.

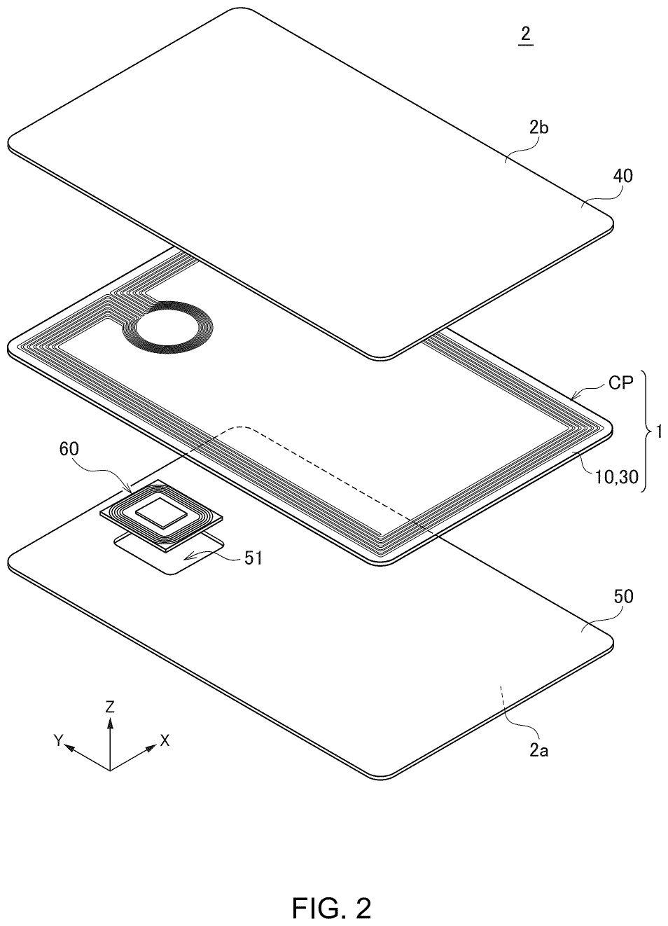

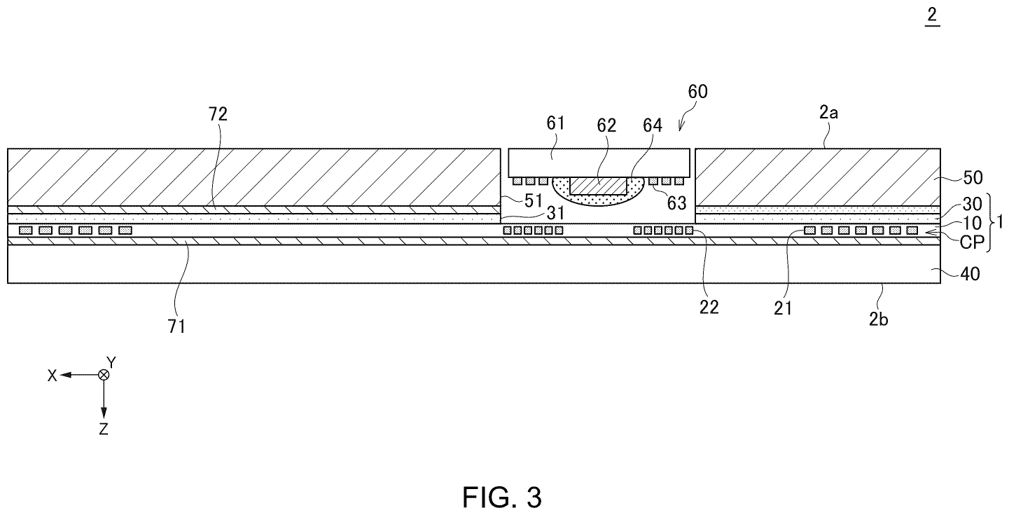

FIGS. 2 and 3 are respectively a schematic exploded perspective view and a schematic cross-sectional view for explaining the structure of the IC card 2 having a coil pattern CP according to the present embodiment.

The IC card 2 illustrated in FIGS. 2 and 3 has a structure in which a plastic plate 40, a coil component 1, and a metal plate 50 are laminated in this order from the back surface 2b side to the upper surface 2a side. The coil component 1 includes a magnetic body 30, the coil pattern CP, and a resin layer 10. The coil pattern CP and resin layer 10 are disposed on one surface side (positive Z-direction side) of the magnetic body 30. The coil pattern CP may be embedded in the resin layer 10. The other surface side (negative Z-direction side) of the magnetic body 30 is covered with the metal plate 50.

The magnetic body 30 and metal plate 50 respectively have through holes 31 and 51. The through holes 31 and 51 overlap each other in the Z-direction (lamination direction). The plastic plate 40 and coil component 1 are bonded to each other through an adhesive layer 71. The metal plate 50 and coil component 1 are bonded to each other through an adhesive layer 72. Examples of the material of the adhesive layers 71 and 72 include an acrylic-based double-sided tape, a thermosetting resin, and a thermoplastic resin.

The plastic plate 40 is made of a resin material not blocking magnetic flux. The outer surface of the plastic plate 40 constitutes the back surface 2b of the IC card 2. The metal plate 50 is made of a metal material such as stainless steel or titanium. The outer surface of the metal plate 50 constitutes the upper surface 2a of the IC card 2. The metal plate 50 has a through hole 51 inside of which an IC module 60 is disposed. As described above, the IC card 2 is a card using a metal plate as its main body.

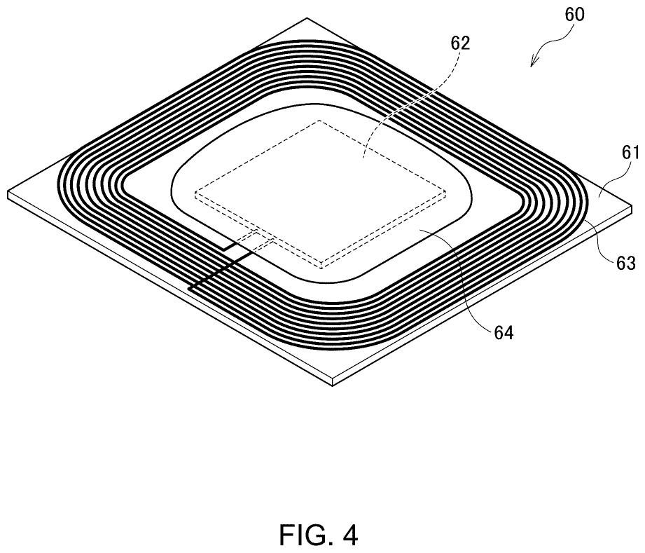

FIG. 4 is a schematic perspective view of the IC module 60 as viewed from the back surface side.

As illustrated in FIG. 4, the IC module 60 includes substrate 61, an IC chip 62 mounted on or a module incorporated in the module substrate 61, and a coupling coil 63. The IC chip 62 is protected by being covered with a dome-shaped protective resin 64. The protective resin 64 is made of an insulating member. The terminal electrode E illustrated in FIG. 1 is provided on the surface of the module substrate 61 on the side opposite to the side on which the IC chip 62 and coupling coil 63 are provided. The IC module 60 thus configured is accommodated in the through hole 51 formed in the metal plate 50. In a state where the IC module 60 is accommodated in the through hole 51, the coupling coil 63 and a second winding part 22 constituting a part of the coil pattern CP are electromagnetically coupled to each h other. Since the second winding part 22 of the coil pattern CP is connected to a first winding part 21, which constitutes another part of the coil pattern CP and functioning as an antenna coil, the IC module 60 can communicate with an external device through the first winding part 21 of the coil pattern CP.

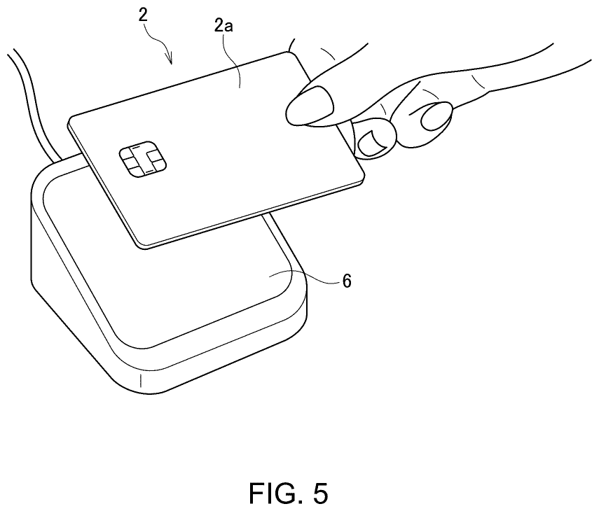

Thus, when the back surface 2b of the IC card 2 is made to face a card reader 6 as illustrated in FIG. 5, communication can be performed between the card reader 6 and the IC chip 62. That is, the card reader 6 is coupled to the coupling coil 63 of the IC module 60 through the coil pattern CP and can thus communicate with the IC chip 62.

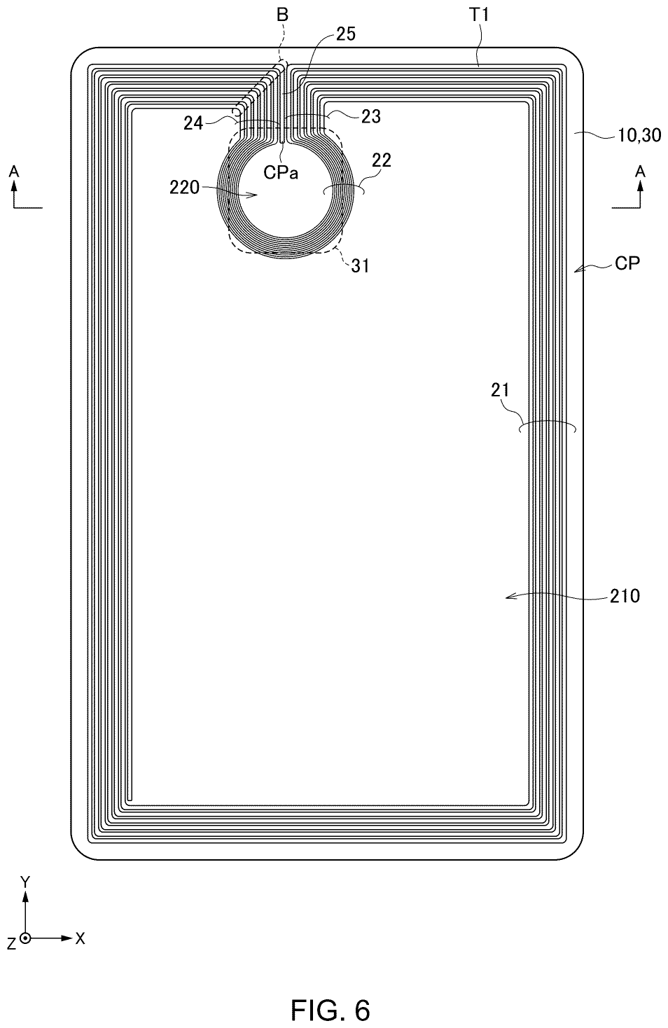

FIG. 6 is a schematic plan view for explaining the configuration of the coil pattern CP according to the present embodiment. The line A-A in FIG. 6 indicates the sectional position of FIG. 3.

As illustrated in FIG. 6, the coil pattern CP according to the present embodiment is constituted by a conductor pattern of a plurality of turns. Each of the plurality of turns constituting the coil pattern CP has the first winding part 21 and second winding part 22. The first winding part 21 is wound in a first direction along the outer edge of the magnetic body 30 so as to overlap the magnetic body 30. The second winding part 22 is positioned in a first opening area 210 surrounded by the first winding part 21 and wound in a second direction opposite to the first direction. The coil pattern CP may include one or more turns that do not include one of the first and second winding parts 21 and 22 or that include neither the first winding part 21 nor second winding part 22. When the position B in FIG. 6 is defined as winding start and end points of each turn, one end of the second winding part 22 in each turn and one end of the first winding part 21 in each turn are connected to each other through a first connection part 23, and the other end of the second winding part 22 in each turn and the other end of the first winding part 21 in each turn are connected to each other through a second connection part 24.

The second winding part 22 of the coil pattern CP partially overlaps the through hole 31 of the magnetic body 30. Thus, the second winding part 22 partially overlap, through the through hole 31 of the magnetic body 30, the IC module 60 disposed in the through hole 51 of the metal plate 50 in the Z-direction. In the example illustrated in FIG. 6, only a part of the second winding part 22 of the coil pattern CP overlaps the through hole 31 of the magnetic body 30, and the remaining part thereof overlaps the magnetic body 30. However, the entire second winding part 22 of the coil pattern CP may overlap the through hole 31 of the magnetic body 30. Further, in this example of FIG. 6, the entire second opening area 220 surrounded by the second winding part 22 overlaps the through hole 31 of the magnetic body 30. Further, in this example of FIG. 6, the second winding part 22 of the coil pattern CP has a substantially circular shape, and the through hole 31 of the magnetic body 30 has a substantially square edge, so that the second opening area 220 is wound not along the edge of the through hole 31 of the magnetic body 30. This makes the second winding part 22 less likely to be affected by the metal plate 50 through the through hole 31 of the magnetic body 30, thus reducing a loss due to the existence of the metal plate 50.

In the example illustrated in FIG. 6, the number of turns of the conductor pattern constituting the coil pattern CP is about six. The second winding part 22 of the coil pattern CP is wound so as to protrude toward the first opening area 210 surrounded by the first winding part 21 of the coil pattern CP. That is, each of the turns constituting the coil pattern CP includes the first winding part 21 of less than one turn, the second winding part 22 of less than one turn, and the first and second connection parts 23 and 24 connecting the first and second winding parts 21 and 22.

The first winding part 21 of the coil pattern CP functions as an antenna coil which is coupled to an external card reader in actual use. The second winding part 22 of the coil pattern CP functions as a coupling coil which is coupled to the IC module 60. The second winding part 22 of the coil pattern CP may function as a part of the antenna coil coupled to the external card reader. For example, when the resonance frequency of the coil pattern CP is set to 13.56 MHz or a frequency band around 13.56 MHz, near-field communication (NFC) between the external card reader and the IC card 2 is enabled. Further, when outer and inner peripheral ends CPa and CPb of the coil pattern CP are set respectively to winding start and end points, the first and second winding parts 21 and 22 of the coil pattern CP are wound left-handed (counterclockwise direction) and right-handed (clockwise direction) as viewed in the direction of FIG. 6. That is, the first and second winding parts 21 and 22 are wound in mutually opposite directions. Thus, for example, a first turn T1 is positioned at the outermost periphery in the first winding part 21 whereas it is positioned at the innermost periphery in the second winding part 22.

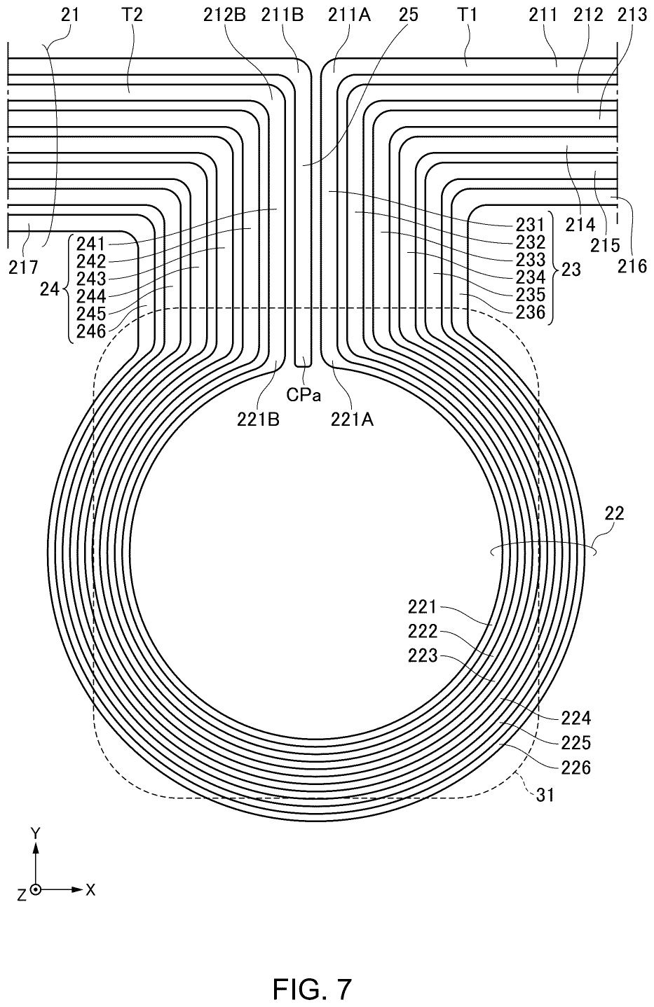

FIG. 7 is an enlarged schematic plan view illustrating the second winding part 22 of the coil pattern CP and its periphery.

In the example illustrated in FIG. 7, the first winding part 21 of the coil pattern CP includes six first winding parts 211 to 216 (and a first winding part 217 positioned at the innermost periphery), and the second winding part 22 of the coil pattern CP includes six second winding parts 221 to 226. The first winding part 211 and second winding part 221 constitute the same turn (first turn T1 wound with the outer peripheral end CPa as the winding start point). The first winding part 211 is positioned at the outermost periphery among the first winding parts 211 to 216, and the second winding part 221 is positioned at the innermost periphery among the second winding parts 221 to 226.

One end 221A of the second winding part 221 and one end 211A of the first winding part 211 are connected to each other through the first connection part 231 linearly extending in the Y-direction. The other end 221B of the second winding part 221 and the other end 212B of the first winding part 212 included in another turn (second turn T2 wound with the outer peripheral end CPa as the winding start point) adjacent to the turn to which the other end 221B belongs are connected to each other through a second connection part 241 linearly extending in the Y-direction. The same applies to the other turns. Specifically, one ends of the second winding parts 222 to 226 and one ends of the first winding parts 212 to 216 are respectively connected to each other through respective first connection parts 232 to 236 linearly extending in the Y-direction, and the other ends of the second winding parts 222 to 226 and the other ends of the first winding parts 213 to 217 included in other turns respectively adjacent to the turns to which the other ends of the second winding parts 222 to 226 belong are respectively connected to each other through respective second connection parts 242 to 246 linearly extending in the Y-direction.

Further, in the present embodiment, the coil pattern CP has an additional pattern 25. The additional pattern 25, which is a part of the first turn T1 wound with the outer peripheral end CPa as the winding start point, is connected to the other end 211B of the first winding part 211 and linearly extends in the Y-direction between the first and second connection parts 231 and 241. In the example illustrated in FIG. 7, the additional pattern 25 is entirely interposed in the Y-direction between the first and second connection parts 231 and 241 so as to prevent them from being directly adjacent to each other in the X-direction.

The additional pattern 25 is provided so as to easily detect, through a characteristic test, a short-circuit failure occurring between adjacent, two connection parts of the plurality of connection parts 231 to 236 and 241 to 246 that extend in the Y-direction. This is achieved by the following mechanism.

If a short-circuit failure occurs between the first and second connection parts 231 and 241 in the absence of the additional pattern 25, the second winding part 221 is bypassed, and thus a change occurs in the characteristics of the second winding part 22 as a coupling coil, resulting in insufficient coupling to the IC module 60. In this case, however, the second winding part 221 is small in diameter, so that even when the SRF (Self Resonance Frequency) of the entire coil pattern CP is measured through a characteristic test, a difference between the SRF of a conforming product and SRF when the first and second connection parts 231 and 241 are short-circuited is small and thus difficult to distinguish.

On the other hand, when the additional pattern 25 is present between the first and second connection parts 231 and 241, a short-circuit failure occurring on the connection parts 231 to 236 and 241 to 246 inevitably bypasses one or more of the first winding parts 211 to 216 constituting the first winding part 21. For example, when the first connection part 231 and additional pattern 25 are short-circuited, the first winding part 211 is bypassed, and when the second connection part 241 and additional pattern 25 are short-circuited, the first winding part 211 and second winding part 221 are bypassed. Thus, in a state where the additional pattern 25 is present, when a short-circuit failure occurs in some of the connection parts 231 to 236 and 241 to 246, one or more of the first winding parts 211 to 216 constituting the first winding part 21 larger in diameter than the second winding part 22 are inevitably bypassed, so that a significant change occur in the SRF. Thus, it is possible to easily determine the presence/absence of the short-circuit failure through a non-defective inspection performed based on the SRF measurement.

When a short-circuit failure occurs in some of the connection parts 231 to 236 and 241 to 246 other than the first and second connection parts 231 and 241, one or more of the first winding parts 211 to 216 constituting the first winding part 21 are inevitably bypassed irrespective of the presence/absence of the additional pattern 25, so that it is possible to easily determine the presence/absence of the short-circuit failure through a non-defective inspection performed based on the SRF measurement. The same applies to a case where a short-circuit failure occurs in the first winding part 21 or second winding part 22. That is, one or more of the first winding parts 211 to 216 constituting the first winding part 21 are bypassed, making it easy to determine the presence/absence of the short-circuit failure.

As described above, the technology according to the present disclosure has been made focusing on the fact that it is difficult to detect a short-circuit occurring between the first and second connection parts 231 and 241 in the turn T1 in which the first and second winding parts 211 and 221 are respectively positioned at the outermost and innermost peripheries, and to cope with this, the additional pattern 25 is provided between the first and second connection parts 231 and 241. Thus, even when any type of short-circuit failures occur in the connection parts 231 to 236 and 241 to 246, a significant change occurs in the SRF, so that it is possible to easily determine the presence/absence of the short-circuit failure through a non-defective inspection performed based on the SRF measurement.

Further, in the present embodiment, the length of the first connection part 231 in the Y-direction is longer than the length of the second connection part 241 in the Y-direction. In the example illustrated in FIG. 7, a difference between the length of the first connection part 231 in the Y-direction and the length of the second connection part 241 in the Y-direction is equal to the pattern pitch of the first winding part 21. Specifically, the other end 212B of the first winding part 212, which is the end portion of the second connection part 241 on the first winding part side (positive Y-direction side), is positioned closer to the second opening area 220 side (negative Y-direction side) than the one end 211A of the first winding part 211, which is the end portion of the first connection part 231 on the first winding part side (positive Y-direction side). As a result, the length of the first connection part 231 in the Y-direction is substantially the same as the length of the additional pattern 25 in the Y-direction, thus allowing the position of the one end 211A of the first winding part 211 in the Y-direction and the position of the other end 211B of the first winding part 211 in the Y-direction to substantially coincide with each other. This makes it possible to ensure an adequate diameter of the first winding part 21 in the limited planar size.

That is, when the length of the first connection part 231 in the Y-direction is made to coincide with the length of the second connection part 241 in the Y-direction, the other end 211B of the first winding part 211 connected to the additional pattern 25 protrudes in the Y-direction from the one end 211A of the first winding part 211, resulting in an increase in the planar size of the coil pattern CP. Alternatively, unless the planar size of the coil pattern CP is increased, the diameter of the first winding part 21 is reduced. Such a problem can be eliminated by providing a difference between the lengths of the first and second connection parts 231 and 241.

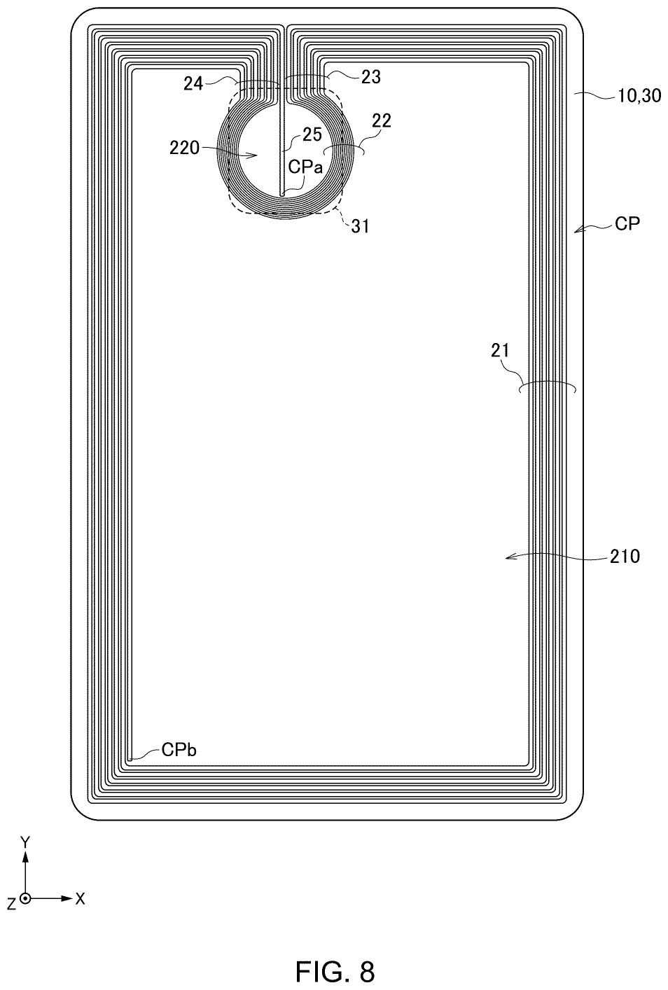

FIG. 8 is a schematic plan view for explaining a first modification of the coil pattern CP.

As illustrated in FIG. 8, the first modification differs from the coil pattern CP illustrated in FIGS. 6 and 7 in that the length of the additional pattern 25 in the Y-direction is increased and that a part of the additional pattern 25 is positioned within the second opening area 220 surrounded by the second winding part 221. Other basic configurations are the same as those of the coil pattern CP illustrated in FIGS. 6 and 7, so the same reference numerals are given to the same elements, and overlapping description will be omitted. According to the first modification illustrated in FIG. 8 in which part of the additional pattern 25 is made to protrude into the second opening area 220, even when a short-circuit failure occurs through the second opening area 220, one or more of the first winding parts 211 to 216 constituting the first winding part 21 are inevitably bypassed, so that it is possible to easily detect the short-circuit failure through the SRF measurement.

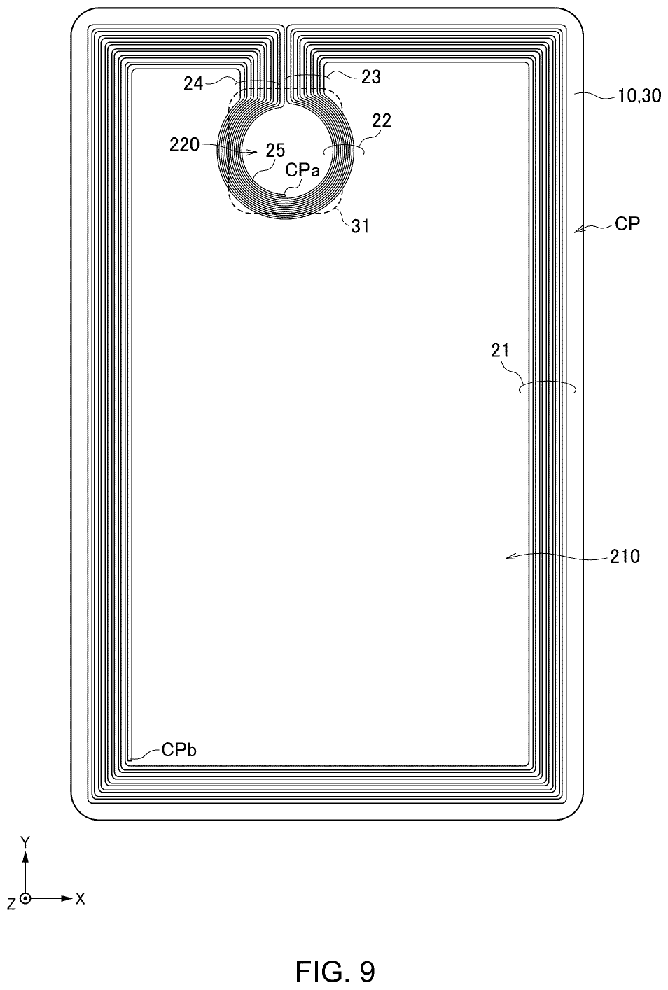

FIG. 9 is a schematic plan view for explaining a second modification of the coil pattern CP.

As illustrated in FIG. 9, the second modification differs from the coil pattern CP illustrated in FIG. 8 in that a part of the additional pattern 25 that is positioned within the second opening area 220 extends along the second winding part 221. Other basic configurations are the same as those of the coil pattern CP illustrated in FIG. 8, so the same reference numerals are given to the same elements, and overlapping description will be omitted. According to the second modification illustrated in FIG. 9, it is possible to reduce interference between magnetic flux passing through the second opening area 220 and the additional pattern 25.

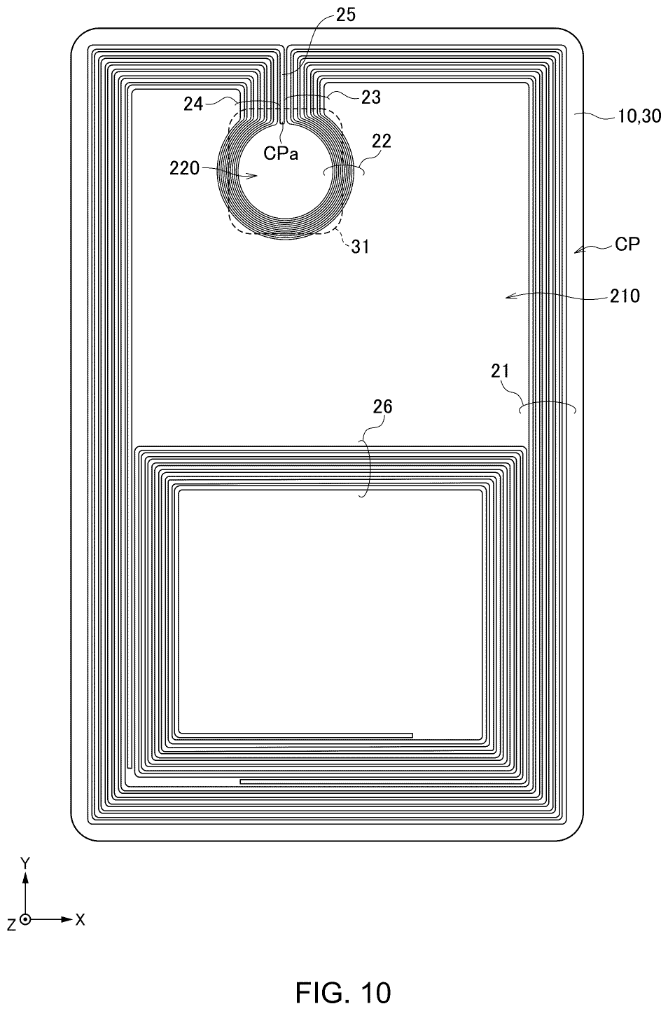

FIG. 10 is a schematic plan view for explaining a third modification of the coil pattern CP.

As illustrated in FIG. 10, the third modification differs from the coil pattern CP illustrated in FIG. 6 in that the coil pattern CP includes a relay turn 26. Other basic configurations are the same as those of the coil pattern CP illustrated in FIG. 6, so the same reference numerals are given to the same elements, and overlapping description will be omitted. The relay turn 26 is a simple turn having neither the first winding part 21 nor second winding part 22, and both the outer and inner peripheral ends thereof are opened. In the example in FIG. 10, the relay turn 26 is wound in about seven turns within the first opening area 210. The relay turn 26 functions as a part of the antenna coil. According to the third modification illustrated in FIG. 10, it is possible to enhance coupling between the coil pattern CP and the card reader 6 and to achieve adjustment of the resonance frequency of the coil pattern CP by the number of turns of the relay turn 26, the size of the opening area, and the like.

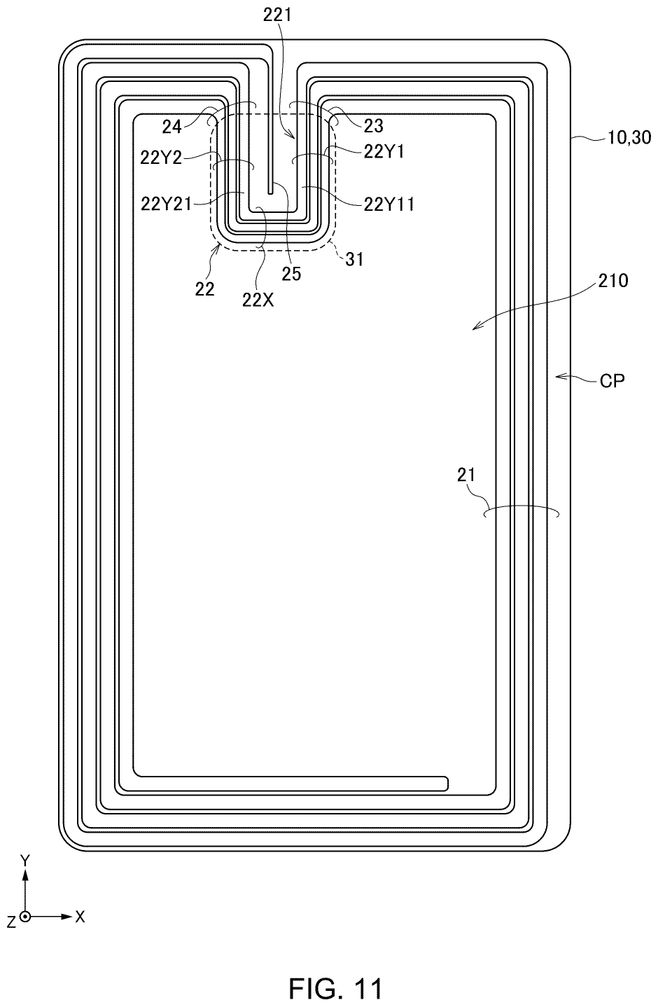

FIG. 11 is a schematic plan view for explaining a fourth modification of the coil pattern CP.

As illustrated in FIG. 11, the fourth modification differs from the coil pattern CP illustrated in FIG. 8 in that the second winding part 22 has a substantially rectangular shape including one section 22X extending in the X-direction and two sections 22Y1 and 22Y2 extending in the Y-direction. That is, in each of the turns constituting the second winding part 22, the winding is wound in about ¾ turns, and the sections 22Y1 and 22Y2 extending in the Y-direction are directly connected respectively to the first and second connection parts 23 and 24. When the coil pattern CP has such a shape, a part of the coil pattern CP that overlaps the through hole 31 of the magnetic body 30 may be defined as the second winding part 22, and a part thereof that overlaps the magnetic body 30 may be defined as the first connection part 23 or second connection part 24. Then, when the additional pattern 25 that extends in the Y-direction is provided between two sections 22Y11 and 22Y21 extending in the Y-direction that constitute the innermost second winding part 221 of the second winding part 22, it is possible to easily detect a short-circuit failure occurring between the sections 22Y11 and 22Y21.

Further, in the example illustrated in FIG. 11, the pattern width of the additional pattern 25 is smaller than the pattern widths of the first and second winding parts 21 and 22. When the pattern width of the additional pattern 25 is thus designed small, it is possible to further reduce interference between the additional pattern 25 and the magnetic flux.

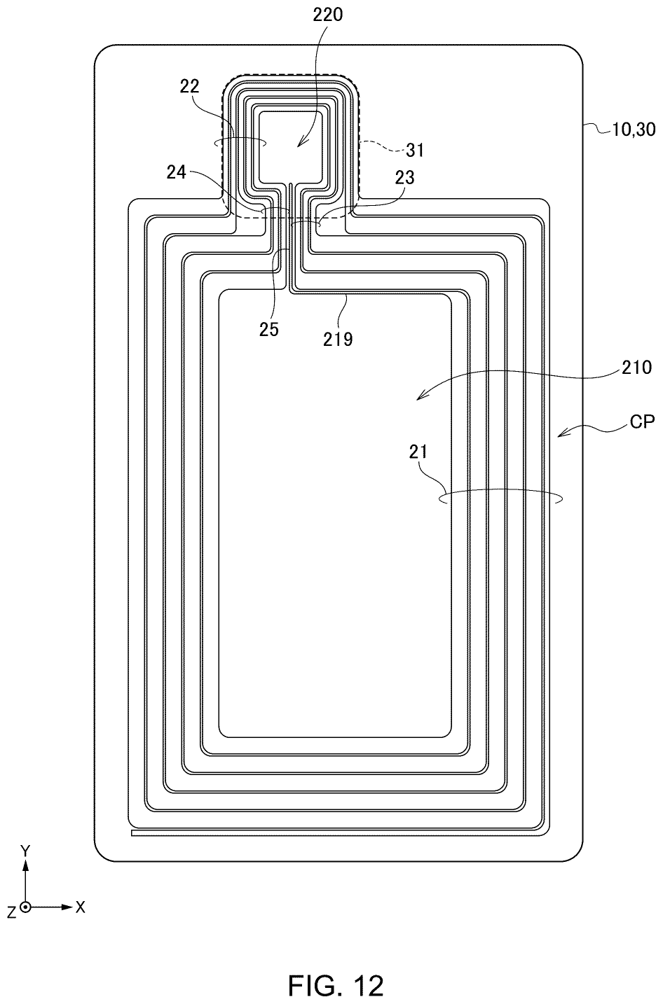

FIG. 12 is a schematic plan view for explaining a fifth modification of the coil pattern CP.

As illustrated in FIG. 12, the fifth modification differs from the coil pattern CP illustrated in FIG. 11 in that the second winding part 22 protrudes outside the first winding part 21 in the radial direction and that a first winding part 219 positioned at the innermost periphery has the additional pattern 25. Other basic configurations are the same as those of the coil pattern CP illustrated in FIG. 11, so the same reference numerals are given to the same elements, and overlapping description will be omitted.

In the example illustrated in FIG. 12, the second winding part 22 protrudes outside the first winding part 21 in the radial direction, so that the winding direction of the first winding part 21 and that of the second winding part 22 are the same as each other. Further, the second opening area 220 surrounded by the second winding part 22 is positioned outside the first opening area 210 surrounded by the first winding part 21 and does not overlap the first opening area 210.

The additional pattern 25 extends in the positive Y-direction from the first winding part 219 positioned at the innermost periphery while passing between the first and second connection parts 23 and 24. The leading end of the additional pattern 25 may be positioned within the second opening area 220. As exemplified in the fifth modification illustrated in FIG. 12, the winding direction of the first winding part 21 of the coil pattern CP and that of the second winding part 22 may be the same as each other.

While some embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A coil pattern according to an embodiment of the present disclosure is a coil pattern having a plurality of turns, wherein at least some of the plurality of turns includes: a first winding part wound in a first direction so as to surround a first opening area; a second winding part wound in a second direction so as to surround a second opening area; a first connection part connecting one end of the second winding part and one end of the first winding part; and a second connection part connecting the other end of the second winding part and the other end of the first winding part included in another turn adjacent to the turn to which the other end of the second winding part belongs, and a first turn of the plurality of turns which is positioned at the innermost periphery in the second winding part extends between the first and second connection parts and includes an additional pattern connected to the other end of the first winding part. With this configuration, when a short-circuit failure occurs between the additional pattern and the first connection part or second connection part, the first winding part constituting the first turn is bypassed, thus making it possible to easily detect the short-circuit failure from a change in the SRF.

In the above coil pattern, the second direction may be opposite to the first direction. Thus, the second opening area is disposed within the first opening area, making it possible to reduce the outer size of the coil pattern.

In the above coil pattern, the additional pattern may be entirely interposed between the first and second connection parts included in the first turn so as to prevent the first and second connection parts included in the first turn from being directly adjacent to each other. Thus, a short-circuit failure will by no means occur between the first and second connection parts without intervention of the additional pattern, making it possible to detect a short-circuit failure more reliably.

In the above coil pattern, a part of the additional pattern may be positioned in the second opening area surrounded by the second winding part included in the first turn. Thus, when a short-circuit failure occurs between the additional pattern and the innermost turn of the second winding part, the first winding part constituting the first turn is bypassed, so that it is possible to detect the short-circuit failure more reliably.

In the above coil pattern, the part of the additional pattern may extend along the second winding part included in the first turn. This can reduce interference between the additional pattern and the magnetic flux.

In the above coil pattern, the first winding part side end portion of the second connection part included in the first turn may be positioned closer to the second opening area side than the first winding part side end portion of the first connection part included in the first turn. This makes it possible to ensure an adequate diameter of the first winding part in the limited planar size.

An IC card according to an embodiment of the present disclosure includes the above coil pattern. Thus, there can be provided an IC card free from a short-circuit failure.

What is claimed is:

1. A coil pattern comprising a plurality of turns,
wherein each of at least some of the plurality of turns includes:
a first winding part wound in a first direction so as to surround a first opening area;
a second winding part wound in a second direction so as to surround a second opening area;
a first connection part connecting one end of the second winding part and one end of the first winding part; and
a second connection part connecting other end of the second winding part and other end of the first winding part included in an adjacent turn,
wherein the plurality of turns include a first turn positioned at an innermost periphery in the second winding part, and
wherein the first turn includes an additional pattern extending between the first and second connection parts and connected to the other end of the first winding part.

2. The coil pattern as claimed in claim 1, wherein the second direction is opposite to the first direction.

3. The coil pattern as claimed in claim 1, wherein the additional pattern is entirely interposed between the first and second connection parts included in the first turn so as to prevent the first and second connection parts included in the first turn from being directly adjacent to each other.

4. The coil pattern as claimed in claim 3, wherein a part of the additional pattern is positioned in the second opening area.

5. The coil pattern as claimed in claim 4, wherein the part of the additional pattern extends along the second winding part included in the first turn.

6. The coil pattern as claimed in claim 1, wherein the first winding part side end portion of the second connection part included in the first turn is positioned closer to the second opening area side than the first winding part side end portion of the first connection part included in the first turn.

7. An IC card comprising a coil pattern,
wherein the coil pattern includes a plurality of turns,
wherein each of at least some of the plurality of turns includes:
a first winding part wound in a first direction so as to surround a first opening area;
a second winding part wound in a second direction so as to surround a second opening area;
a first connection part connecting one end of the second winding part and one end of the first winding part; and
a second connection part connecting other end of the second winding part and other end of the first winding part included in an adjacent turn,
wherein the plurality of turns include a first turn positioned at an innermost periphery in the second winding part, and
wherein the first turn includes an additional pattern extending between the first and second connection parts and connected to the other end of the first winding part.
